(19) United States
(12) Patent Application Publication
(10) Pub. No.: US 2026/0213691 A1
(43) Pub. Date: Jul. 23, 2026

(54) CONTROLLING MOTOR OF POWER TOOL

(71) Applicant: Mirka Ltd., Jepua (FI)

(72) Inventors: Tomas SÖDERGÅRD, Nykarleby (FI); Caj NORDSTRÖM, Jeppo (FI)

(21) Appl. No.: 19/140,296

(22) PCT Filed: Dec. 18, 2023
(86) PCT No.: PCT/FI2023/050711

§ 371 Date: Jun. 17, 2025

(30) Foreign Application Priority Data
Dec. 20, 2022 (FI) 20226133

(51) Int. Cl. H02P 29/028; B25F 5/00; H02P 29/032; H02P 29/10

(52) U.S. Cl. CPC H02P 29/028; B25F 5/001; H02P 29/032; H02P 29/10; H02P 2205/01; H02P 2205/07

(57) ABSTRACT

There is provided a method for controlling a motor of a power tool, comprising measuring at least one current value output by a power switching network connected to the motor of the power tool, measuring a speed of the motor, determining a power limit corresponding to the measured speed of the motor, determining based on the determined power limit and the measured speed of the motor a current limit setting corresponding to the determined power limit, determining at least one control mode for driving the motor based on whether the measured at least one current value has met the determined current limit setting corresponding to the determined power limit, and controlling the power switching network to drive the motor according to the determined at least one control mode.

### TECHNICAL FIELD

The present invention relates controlling a motor of a power tool.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Motor speed of power tool can be controlled based on limiting current that is fed to the motor. However, when a current limit is reached, the motor speed and power can drop rapidly. When the power tool is loaded, a rapid change, i.e. decrease, of the motor speed and power can cause the motor speed and power to become out of a desired motor speed and power of the power tool. The rapid change of the motor speed and power can lead to a decreased quality of work and even stalling of the motor. Therefore, the rapid change of the motor speed and power is a discontinuity in the work performed using the power tool and in order to continue working, the power tool needs to pick-up the motor speed and power to continue working on an object. When the power tool is a handheld tool, the rapid change of the motor speed and power are undesirable features at least because any corrective actions are dependent on human behavior and therefore dependent on individual differences. User of the power tool can experience the rapid decrease of the motor speed and power as a weakness of the power tool.

### SUMMARY

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to some aspects, there is provided the subject matter of the independent claims. Some further aspects are defined in the dependent claims. The embodiments that do not fall under the scope of the claims are to be interpreted as examples useful for understanding the disclosure.

According to a first aspect there is provided a method comprising:
measuring at least one current value output by a power switching network connected to a motor of the power tool;
measuring a speed of the motor;
determining a power limit corresponding to the measured speed of the motor;
determining based on the determined power limit and the measured speed of the motor a current limit corresponding to the determined power limit;
determining at least one control mode for driving the motor based on whether the measured at least one current value has met the determined current limit corresponding to the determined power limit; and
controlling the power switching network to drive the motor according to the determined at least one control mode.

According to a second aspect there is provided a power tool for controlling motor speed of a power tool, said power tool comprising a controller connected to a current sensor, a speed sensor and a power switching network for driving a motor, wherein the power tool is configured to:
measure, by the controller, at least one current value output by a power switching network connected to a motor of the power tool;
measure, by the controller, a speed of the motor;
determine a power limit corresponding to the measured speed of the motor;
determine, by the controller, based on the determined power limit and the measured speed of the motor a current limit corresponding to the determined power limit;
determine, by the controller, at least one control mode for driving the motor based on whether the measured at least one current value has met the determined current limit corresponding to the determined power limit; and
control, by the controller, the power switching network to drive the motor based on the determined at least one control mode.

According to a third aspect there is provided an apparatus comprising:
means for measuring at least one current value output by a power switching network connected to a motor of the power tool;
means for measuring a speed of the motor;
means for determining a power limit corresponding to the measured speed of the motor;
means for determining based on the determined power limit and the measured speed of the motor a current limit corresponding to the determined power limit;
means for determining at least one control mode for driving the motor based on whether the measured at least one current value has met the determined current limit corresponding to the determined power limit; and
means for controlling the power switching network to drive the motor according to the determined at least one control mode.

According to one or more further aspects the one or more of the first, second and third aspects comprise one or more of the following:
determining, based on the determined power limit and the measured speed of the motor, an upper current limit and a lower current limit;
controlling the power switching network to drive the motor at a speed mode, if the measured at least one current value is less than the lower current limit;
controlling the power switching network to drive the motor at an intermediate mode, if the measured at least one current value is equal to or between the lower current limit and the higher current limit;
controlling the power switching network to drive the motor at a current mode if the measured at least one current value is above the higher current limit;
wherein the current limit setting comprises a range of current values between a higher current limit and a lower current limit;
the power tool is a polisher, sander, grinder, screwdriver, impact driver, drill, circular saw, chain saw or jack hammer;
At least some of the embodiments provide that abrupt changes to the speed of the motor as a function of load may be avoided.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a power tool in accordance with at least some embodiments;

FIGS. 2 and 3 illustrate examples of block diagrams for power tools in accordance with at last some embodiments;

FIG. 4 illustrates an example of a method for controlling a motor of a power tool in accordance with at least some embodiments;

FIG. 5 illustrates an example of a method for controlling a motor of a power tool in accordance with at least some embodiments; and

FIG. 6 illustrates an example of a block diagram for an apparatus for controlling a motor of a power tool in accordance with at least some embodiments.

### DETAILED DESCRIPTION OF SOME EXAMPLE EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

As used herein, “at least one of the following:” and “at least one of” and similar wording, where the list of two or more elements are joined by “and” or “or”, mean at least any one of the elements, or at least any two or more of the elements, or at least all the elements.

Use of ordinal terms such as “first,” “second,” “third,” etc., in the claims and description to modify a described feature does not by itself connote any priority, precedence, or order of one described feature over another or the temporal order in which acts of a method are performed, but are used merely as labels to distinguish one described feature having a certain name from another described feature having a same name (but for use of the ordinal term) to distinguish the described feature.

Identical or corresponding functional and structural elements which appear in the different drawings are assigned the same reference numerals. When the words first and second are used to refer to different elements, it is to be understood that this does not necessarily imply or mean that the first and second elements are somehow structurally substantially different elements or that their dimensions are substantially different unless specifically stated.

It should be noted that in the following, numeric values for dimensions are presented using comma for separating decimals.

There is provided method for controlling motor of a power tool, comprising measuring at least one current value output by a power switching network connected to a motor of the power tool, measuring a speed of the motor, determining a power limit corresponding to the measured speed of the motor, determining based on the determined power limit and the measured speed of the motor a current limit corresponding to the determined power limit, and determining at least one control mode for driving the motor based on whether the measured at least one current value has met the determined current limit corresponding to the determined power limit, and controlling the power switching network to drive the motor according to the determined at least one control mode. Since current limit setting is determined based on the power limit, a change, e.g. decrease, of load to the motor can cause that the motor speed is also changed, e.g. decreased. However, the measured current and the current limit setting may be used to determine the control mode for driving the motor. Accordingly, the control mode depends on the measured current and the determined current limit setting, whereby abrupt changes to the motor speed may be avoided. In accordance with at least some embodiments, the control modes comprise one or more of a constant speed mode, an intermediate mode and a current mode. In an example, each of the control modes may comprise determining a target current to be fed to the power switching network and determining a control signal based on the determined target current. An example of the control signal is a pulse-width-modulation signal.

It should be noted that a current mode may be a control mode, where a variation of current output by a power switching network connected to a motor may be kept at an acceptable level.

It should be noted that a speed mode may be a control mode, where a variation of speed of a motor may be kept at an acceptable level. Accordingly, a speed control command may be set such that the variation of the speed may be kept at an acceptable level and preferably minimized.

It should be noted that an intermediate mode may be a control mode, where a current output by a power switching network connected a motor is between a higher current limit and a lower current limit of a current limit setting. At the intermediate mode the current limits are set as a function of the speed of the motor.

It should be noted that, in the speed mode, the current output by a power switching network connected to a motor is less than the lower current limit of the intermediate mode. Accordingly, a current limit applied at the speed mode is the lower current limit of the intermediate mode. When the current exceeds the current limit at the speed mode, the intermediate control mode may be applied. When the current exceeds the higher current limit at the intermediate mode, the current mode is applied.

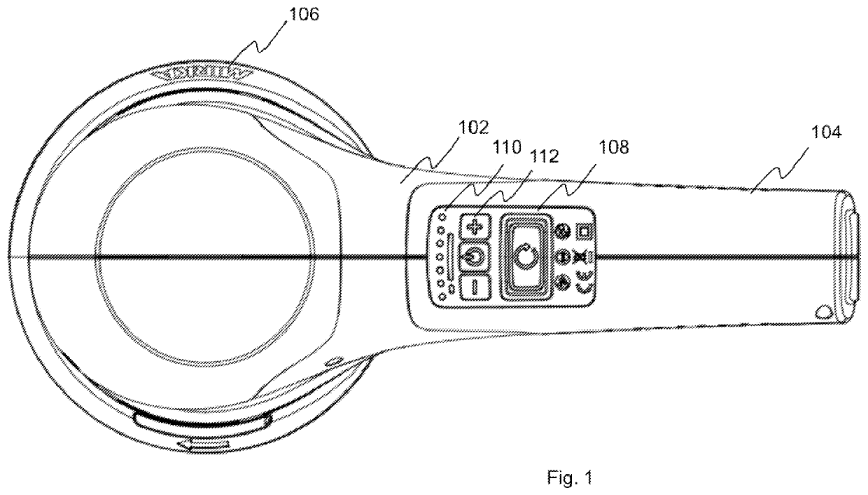

FIG. 1 illustrates an example of a power tool in accordance with at least some embodiments. Examples of power tools comprise at least polishers, sanders, grinders, screwdrivers, impact drivers, drills, circular saws, chain saws or jack hammers. The power tool is illustrated from above. The power tool comprises a housing 102 and a motor arranged inside the housing. The motor comprises an output shaft for connecting tools and/or accessories 106 to be driven by the output shaft. In the illustrated example the housing has a pass-through below the power tool, thus on a side of the power tool that is opposite to a viewing direction of FIG. 1. The pass-through allows the tools and/or accessories to be connected to the output shaft. The housing comprises a handle portion 104 that is adapted for gripping by a user. Accordingly, the power tool may be a handheld power tool. The power tool comprises an operating panel 108 for controlling an operation of the power tool. The operating panel may comprise one or more user input functionalities for receiving user input and one or more user output functionalities for providing information to a user regarding operation of the power tool. The one or more user input functionalities may be implemented by one or more user input devices. The one or more user output functionalities may be implemented by one or more user output devices. Examples of the user input devices comprise at least buttons 112 for receiving commands based on user touch. In an example at least one of the buttons may have a speed potentiometer. The speed potentiometer many dictate a target speed set by user. Examples of the output devices comprise at least lights 110, display devices, sound devices and speakers for communicating information to users. The user input devices may provide controlling the power tool, e.g. setting a speed, such as a maximum speed, of the power tool. The user output devices may provide presenting a motor speed of the power tool to the user.

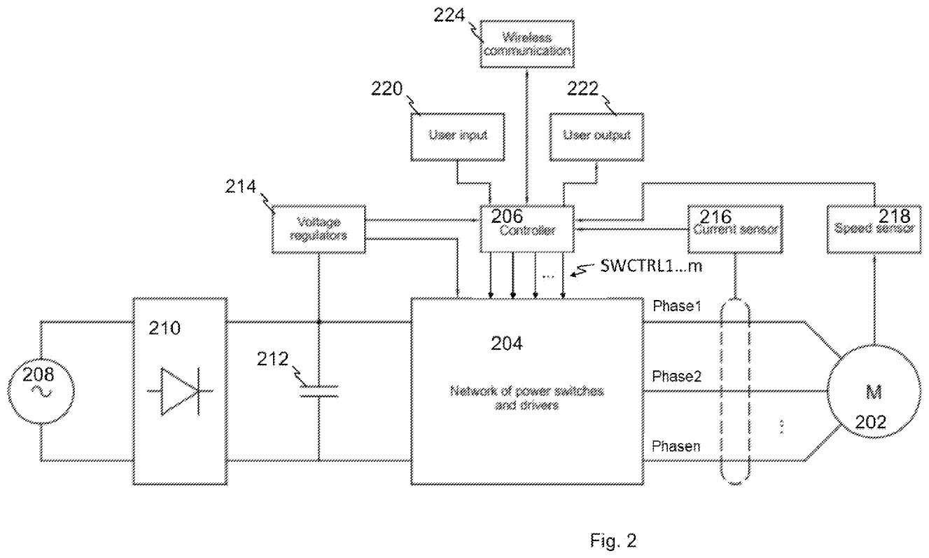

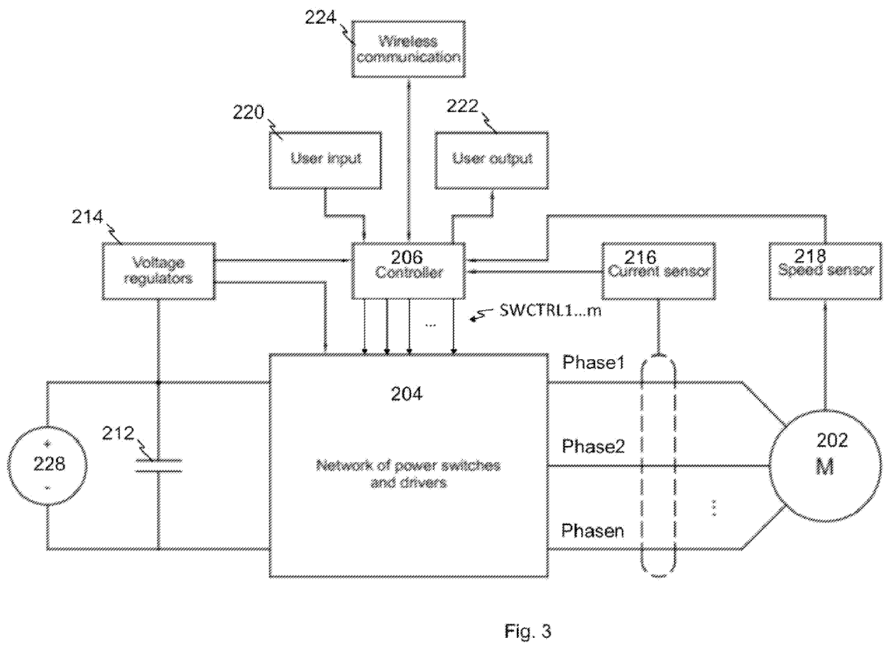

FIGS. 2 and 3 illustrate examples of block diagrams for apparatuses in accordance with at last some embodiments. The apparatuses may be power tools. The apparatuses provide controlling a motor 202 in a power tool for example described with FIG. 1. In an example, the motor may be a brushed DC (Direct Current) motor, a BLDC (Brushless DC) motor or a Switched Reluctance Motor (SRM). A power switching network 204 is connected to the motor for driving the motor. The power switching network may connect the motor by leads corresponding to each phase. Thus, the power switching network may be connected to an n-phase motor by leads corresponding to each phase, thus n leads, {Phase1, Phase2, . . . , Phasen}, where n is an integer for the number of phases. The power switching network comprises m switches and drive circuitries corresponding to each of the switches, where m is an integer for the number of switches. A controller 206 is connected to the power switching network for controlling the m switches. Accordingly, each switch may be connected by the controller by a corresponding lead, {SWCTRL1, SWCTRL2, . . . , SWCTRLm}, from the controller. Examples of the controller comprise a Microcontroller (MCU), Field Programmable Gate Array (FPGA), an Application Specific Integrated Circuit (ASIC) and a processor.

In an example, an AC (Alternating Current) voltage source 208 may be connected to a voltage rectifier 210, e.g. a full bridge rectifier, for obtaining a DC voltage that may be used for powering the power switching network 204 and the controller 206. In an example, a rectified voltage from the voltage rectifier 210 may be filtered by a capacitor 212 and fed to voltage regulators 214 for generating voltages that are fed to the controller 206 and the power switching network 204. In an example, the voltage regulators may feed 12 V to the power switching network and 3.3 V to the controller.

In an example, a DC voltage source 228, for example a battery, may be connected to a voltage rectifier 210, e.g. a full bridge rectifier, for obtaining a DC voltage that may be used for powering the power switching network 204 and the controller 206.

A current sensor 216 may be connected to the controller 206 for measuring current values output from the power switching network and a speed sensor 218 may be connected to the controller for measuring a speed of the motor 202. The current sensor may be configured to measure a phase current of each phase connected to the motor. In an example, a phase current may be measured based on a single shunt resistor in a return path of each half-bridge of the power switching network. The speed sensor may be a dedicated sensor device/circuitry. On the other hand it should be noted that the speed sensor may be implemented without a dedicated sensor device based on a back electromotive force (BEMF) of the motor.

In an example, the motor 202 may be a three phase BLDC motor, thus n is 3, whereby the power switching network comprises three half bridges consisting of m switches, or transistors, and drive circuitries for said switches. Since n=3 and m=2×n, m becomes 6. It should be noted that m=2×n is only an example that is valid in most cases and the relationship between m and n may be different depending on implementation. In another example, a single-phase BLDC motor may have n=2, whereby m becomes 4 using the above relationship between m and n.

In an example, the power tool may comprise one or more user input devices 220 and one or more user output devices 222. The one or more user input devices may be configured to implement one or more user input functionalities. The one or more user output devices may be configured to implement one or more user output functionalities. The user input devices may provide controlling the power tool, e.g. setting a speed, such as a maximum speed, of the power tool. The user output devices may provide presenting a motor speed of the power tool to the user.

In an example, the power tool may comprise a wireless communications module 224 connected to the controller. The wireless communications module enables reading data from the controller and writing data to the controller. Data written to the controller may comprise parameters for controlling a speed of the motor. Data read from the controller may comprise parameters for controlling a speed of the motor, measured current value(s) and measured motor speed value(s). Examples of the parameters for controlling the motor comprise at least a power limits, a speed limit and an idle speed of the motor.

In an example, an apparatus in accordance with at least some embodiments comprises a controller 206 connected to a current sensor 216, a speed sensor 218 and a power switching network 204 for driving a motor. In some embodiments, the apparatus may comprise further devices examples of which are described in FIGS. 2 and 3.

In an example, an apparatus in accordance with at least some embodiments comprises a controller 206 configured to perform one or more functionalities described with a method according to an embodiment. For example, at least some of the blocks for the apparatus described in FIGS. 2 and 3 may be combined into a single block. In an example, some of the blocks described in FIGS. 2 and 3 may be combined into the controller 206. Examples of the controller comprise at least an MCU, an FPGA, an ASIC and a processor. The controller may be operatively connected to a memory. The memory may be a built-in or the memory may be external to the controller. The memory may store computer readable program code means that when executed by the controller cause one or more functionalities described with a method according to an embodiment.

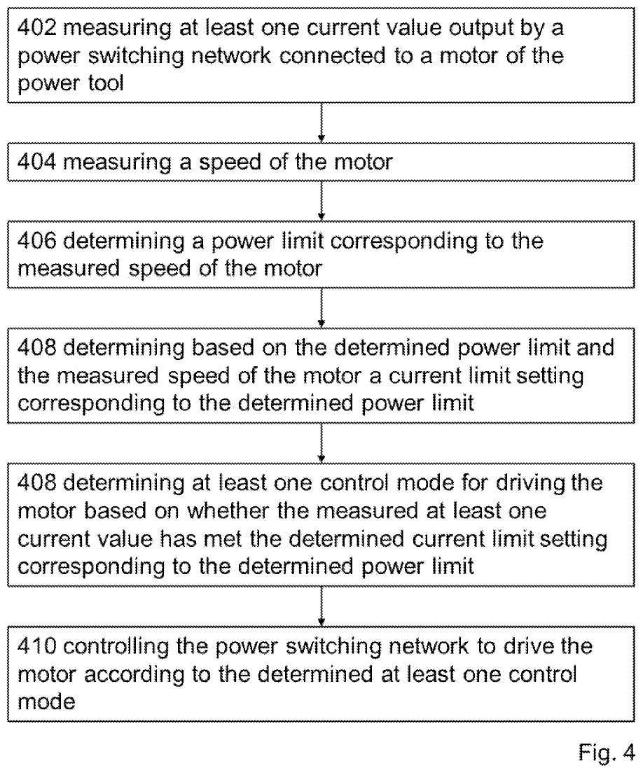

FIG. 4 illustrates an example of a method for controlling a motor of a power tool. The method provides that abrupt changes to the speed of the motor as a function of load may be avoided. The method may be performed by a controller connected to a current sensor, a speed sensor and a power switching network for driving the motor, for example the controller 206 described with FIG. 2.

Phase 402 comprises measuring at least one current value output by a power switching network connected to a motor of the power tool.

Phase 404 comprises measuring a speed of the motor.

Phase 406 comprises determining a power limit corresponding to the measured speed of the motor.

Phase 408 comprises determining based on the determined power limit and the measured speed of the motor a current limit setting corresponding to the determined power limit.

Phase 410 comprises determining at least one control mode for driving the motor based on whether the measured at least one current value has met the determined current limit setting corresponding to the determined power limit.

Phase 412 comprises controlling the power switching network to drive the motor according to the determined at least one control mode.

In an example in accordance with at least some embodiments, the current limit setting comprises a range of current values between a higher current limit and a lower current limit. In this way the current limit setting may be used to determine the control modes for controlling the motor: a speed mode, a current mode and an intermediate mode.

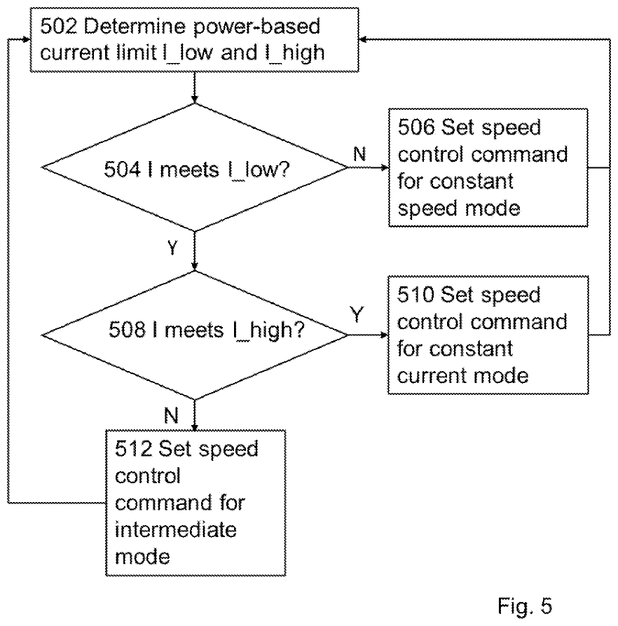

FIG. 5 illustrates an example of a method for controlling a motor of a power tool. The method provides that abrupt changes to the speed of the motor as a function of load may be avoided. The method may be performed by a controller connected to a current sensor, a speed sensor and a power switching network for driving the motor, for example the controller 206 described with FIG. 2, for example, in connection with phase 408 in FIG. 4.

Phase 502 comprises determining a lower current limit and a higher current limit for a current limit setting corresponding to a power limit.

Phase 504 comprises determining if the measured at least one current value has met the lower current limit.

Phase 506 comprises controlling the power switching network to drive the motor at a speed mode, if the measured at least one current value has not met the lower current limit. In an example, the speed control command may be set to the lower current limit. The method may proceed from phase 506 to phase 502.

Phase 508 comprises determining if the measured at least one current value has met the higher current limit if the lower current limit has been met.

Phase 510 comprises controlling the power switching network to drive the motor at a current mode, if the measured at least one current value has met the higher current limit. In an example, the speed control command may be set to the higher current limit. The method may proceed from phase 510 to phase 502.

Phase 512 comprises controlling the power switching network to drive the motor at an intermediate mode. In an example at the intermediate mode the speed control command may be set based on a target current that is between the lower current limit and the higher current limit. The method may proceed from phase 512 to phase 502. In an example, at the intermediate mode power of the motor may be slowly decreasing as the load is increased.

It should be noted that the speed control command in phases 506, 510 and 512 may be used to generate a control signal, or at least one property of the control signal, for controlling the power switching network to drive the motor. An example of the control signal is a pulse-width modulation (PWM) signal. An example of a property of the PWM signal is a PWM duty cycle. At a given time instant, the PWM signal generated based on a speed control command may be mapped to the switches of the power switching network based on a commutation step and a switching pattern. In this way, the PWM value may be used to determine control signals to the SWCTRLs.

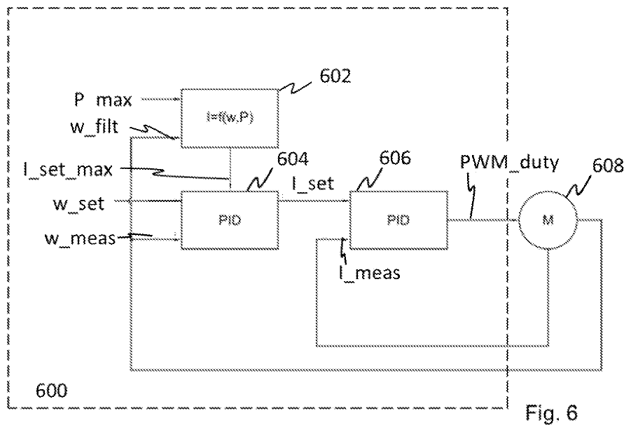

FIG. 6 illustrates an example of a block diagram for an apparatus 600 for controlling a motor of a power tool in accordance with at least some embodiments. The apparatus may be a controller 206 described with FIGS. 2 and 3. The block diagram of FIG. 6 illustrates blocks that are logical entities for implementing functionalities in accordance with at least some embodiments. The blocks may be implemented by physical devices in various ways examples of which are described in FIGS. 2 and 3. The block diagram shows a cascaded connection of two proportional-integral-derivative (PID) controllers for performing one or more phases described with the method of FIG. 5. Accordingly, the PID controllers may be used for implementing the controller 206 in FIG. 2 and FIG. 3. The PID controllers comprise an outer controller 604 and an inner controller 606 that determine an upper current limit and a lower current limit based on a measured speed and a power limit corresponding to the measured speed of the motor. In an example, in accordance with at least some embodiments, the upper current limit and the lower current limit may be used to determine three control modes comprising: a speed mode, an intermediate mode and a current mode. The control modes may be selected based on the lower current limit and higher current limits in accordance to described with phases 504 and 508.

The outer controller 604 receives the measured motor speed (w_meas) as input and calculates a current (L_set) as output. The I_set determines a target current, e.g. a target phase current, of the motor. The target current is between the upper current limit and the lower current limit. The I_set may be used for determining a control signal, or at least one property of the control signal, for controlling a power switching network to drive the motor. It should be noted that the control signal may also be referred to a speed control command. An example of the control signal is a pulse-width modulation (PWM) signal. An example of a property of the PWM signal is a PWM duty cycle. The inner controller 606 receives a measured current (I_meas), thus one or more current values, output by the power switching network and the I_set from the outer PID controller as inputs and generates a control signal (PWM_duty), e.g. a PWM signal or PWM duty cycle, as output. The PWM_duty is used to control the power switching network to drive the motor, whereby the motor 608 may be controlled.

At block 602 a power limit (P_max) and the measured motor speed that may have been filtered (w_filt) may be received as input for calculating a current limit setting (I_set_max) corresponding to the determined power limit. In this way, the control provided by the apparatus 600 is based on the power limit (P_max), e.g. a maximum power. The power limit may represent a maximum power fed by the power switching network to drive the motor or the power limit may represent a maximum mechanical output power of the motor, e.g. based on a torque of the motor. The power limit may be determined based on a user input received via a user input device of the power tool. The user input may be a setting of the user for a speed of the motor [rpm], e.g. a maximum motor speed. It should be noted that the I_set_max may be an upper limit for the electrical current fed to the motor. The I_set_max may be fed to the outer PID controller 604. At the outer PID controller, the I_set_max may be used for determining a control mode for the power switching network.

In an example the power limit (P_max) at block 602 may be used for determining the current limit setting based on the proportionality of power P of the motor with the measured speed of the motor and electrical current fed to the motor as follows:

$${P}_{el} = U \cdot I \qquad ( 1 )$$

$${P}_{mec} = ω \cdot T = \frac{π \cdot n \cdot T}{30} , \qquad ( 2 )$$

where Pₑₗ is electrical power in Watts [W] for driving the motor 608 and P_{mec} is a mechanical power in Watts [W] output by the motor. The remaining symbols are as follows: U=Voltage [V]; I=Current [I]; ω=Angular velocity [rad/s]; T=Torque [Nm]; n=Revolutions per minute [rpm], i.e. speed. The power P, i.e. Pₑₗ and P_{mec}, can be estimated based on the n and l as follows:

$$P ∝ n \cdot I . \qquad ( 3 )$$

The formula (3) may be simplified by replacing the proportionality by equality, whereby I may be expressed as follows:

$$I = \frac{P}{n} . \qquad ( 4 )$$

The formula (4) may be used to determine the current limit setting (I_set_max). It should be noted that due to the formula (3) being simplified to formula (4), in formula (4) the power P, e.g. maximum power or power limit, may be scaled in order to arrive in the current limit setting, or a current value, that corresponds to the P_max with sufficient accuracy.

At block 606, at least one current value output by a power switching network connected to a motor of the power tool may be used for determining a control mode for controlling the power switching network to drive the motor. In accordance with at least some embodiments, block 606 may comprise performing at least one of the following:
controlling the power switching network to drive the motor at the speed mode, if the measured at least one current value is less than the lower current limit; or
controlling the power switching network to drive the motor at the intermediate mode, if the measured at least one current value is equal to or between the lower current limit and the higher current limit; or
controlling the power switching network to drive the motor at the current mode if the measured at least one current value is above the higher current limit.

In an example, at block 604 the measured motor speed (w_meas) and a set motor speed (w_set) may be received as input and a difference between the set motor speed and the measured may be determined. In an example the w_set may be determined based on user input via a user input device of the power tool. It should be noted that at block 604 the I_set may have the I_set_max as an upper bound, whereby I_set cannot exceed I_set_max. In this way the I_set may be determined based on the power limit and the measured speed of the motor. In accordance with at least some embodiments, if the I_set is I_set_max, at block 604, at block 606 the PWM_duty is generated and fed to the power switching network for driving the motor at a current mode in accordance to described with phase 510.

In an example, at block 606, a difference between the I_meas and the I_set is determined and the PWM_duty is determined based on the difference between the I_meas and I_set. If I_meas is less than the I_set, PWM_duty may be generated for controlling the power switching network to drive the motor at a speed mode in accordance to described with phase 506. In an example, at the speed mode the PWM_duty may be determined such that a the I_set is adjusted to minimize changes in the speed of the motor, which is particularly useful, when the power tool is used for working on an object.

In an example, at block 606, it may be determined whether the I_meas is above the I_set. It should be noted that this check is made if the current mode is not applied, thus if I_set is less than I_set_max. Then, if I_meas is above the I_set, PWM_duty may be generated for controlling the power switching network to drive the motor at an intermediate mode in accordance to described with phase 506.

In an example, at block 606, the I_set may be adjusted, or scaled, for driving the motor at the intermediate mode. The I_set may be scaled between the lower current limit and the upper current limit. The scaling may comprise determining a difference between measured current I_meas and the lower current limit and adding that difference to the lower limit. An example of the scaling is defined as follows:

$$I = min ( max ( {I}_{lim , min} , {I}_{lim , min} + ( \frac{P}{n} - {I}_{lim , min} ) K ) , {I}_{lim , max} ) , \qquad ( 5 )$$

where I_{lim,min} is the lower current limit and I_{lim,max} is the upper current limit, min( ) is a function for finding a minimum value, max( ) is a function for finding a maximum value, P is the power and K is a constant. It should be noted that P is a proportionality constant, i.e. a combination of mechanical and electrical properties similar to described with equation (4) above.

Embodiments may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices and other devices. References to computer readable program code means, computer program, computer instructions, program instructions, instructions, computer code etc. should be understood to express software for a programmable processor firmware such as the programmable content of a hardware device as instructions for a processor or configured or configuration settings for a fixed function device, gate array, programmable logic device, etc.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

### REFERENCE SIGNS

102 Housing
104 Handle portion
106 Tools and/or accessories
108 Operating panel
110 Lights
112 Buttons
202 Motor
204 Power switching network
206 Controller
208 AC voltage source
210 Voltage rectifier
212 Capacitor
214 Voltage regulators
216 Current sensor
218 Speed sensor
220 User input devices
222 User output devices
224 Wireless communications module
228 DC voltage source
402, 404,
406, 408,
410 Phases of the method of FIG. 4
502, 504,
506, 508,
510, 512 Phases of the method of FIG. 5
600 Apparatus
602 Block for calculating current limit setting
604 Outer controller
606 Inner controller
608 Motor

1. A method for controlling a motor of a power tool, comprising:
measuring at least one current value output by a power switching network connected to a motor of the power tool;
measuring a speed of the motor;
determining a power limit corresponding to the measured speed of the motor;
determining based on the determined power limit and the measured speed of the motor a current limit setting corresponding to the determined power limit, said current limit setting comprising a higher current limit and a lower current limit; and
determining a control mode for driving the motor based on whether the measured at least one current value has met the determined current limit setting corresponding to the determined power limit, said control mode comprising one of: a speed mode; and an intermediate mode; wherein
the speed mode is determined, if the measured at least one current value is less than the lower current limit; or
the intermediate mode is determined, if the measured at least one current value is equal to or between the lower current limit and the higher current limit; or
the current mode is determined, if the measured at least one current value is above the higher current limit; and
controlling the power switching network to drive the motor according to the determined control mode.

2. The method according to claim 1, wherein the current limit setting comprises a range of current values between a higher current limit and a lower current limit.

3. A power tool comprising:
a controller connected to a current sensor, a speed sensor and a power switching network for driving a motor, wherein the power tool is configured to:
measure, by the controller, at least one current value output by the power switching network connected to the motor of the power tool;
measure, by the controller, a speed of the motor;
determine a power limit corresponding to the measured speed of the motor;
determine, by the controller, based on the determined power limit and the measured speed of the motor a current limit setting corresponding to the determined power limit, said current limit setting comprising a higher current limit and a lower current limit;
determine, by the controller, a control mode for driving the motor based on whether the measured at least one current value has met the determined current limit setting corresponding to the determined power limit, said control mode comprising one of: a speed mode; and an intermediate mode; and a current mode, said control mode comprising one of: a speed mode; and an intermediate mode; wherein
the speed mode is determined, if the measured at least one current value is less than the lower current limit; or
the intermediate mode is determined, if the measured at least one current value is equal to or between the lower current limit and the higher current limit; or
the current mode is determined, if the measured at least one current value is above the higher current limit; and
control, by the controller, the power switching network to drive the motor based on the determined control mode.

4. The power tool according to claim 3, wherein the power tool is a polisher, sander, grinder, screwdriver, impact driver, drill, circular saw, chain saw or jack hammer.

5. An apparatus comprising at least one controller and at least one memory storing instructions that, when executed by the at least one controller, cause the apparatus to perform at least:
measuring at least one current value output by a power switching network connected to a motor of a power tool;
measuring a speed of the motor;
determining a power limit corresponding to the measured speed of the motor;
determining based on the determined power limit and the measured speed of the motor a current limit setting corresponding to the determined power limit, said current limit setting comprising a higher current limit and a lower current limit;
determining a control mode for driving the motor based on whether the measured at least one current value has met the determined current limit setting corresponding to the determined power limit, said control mode comprising one of: a speed mode; and an intermediate mode; and a current mode, said control mode comprising one of: a speed mode; and an intermediate mode; wherein
the speed mode is determined, if the measured at least one current value is less than the lower current limit; or
the intermediate mode is determined, if the measured at least one current value is equal to or between the lower current limit and the higher current limit; or
the current mode is determined, if the measured at least one current value is above the higher current limit; and
controlling the power switching network to drive the motor based on the determined control mode.

6. The apparatus according to claim 5, wherein the current limit setting comprises a range of current values between a higher current limit and a lower current limit.
